(19) United States
(12) Patent Application Publication
(10) Pub. No.: US 2009/0021812 A1
(43) Pub. Date: Jan. 22, 2009

(54) DEVICES FOR RECORDING OR READING OUT AN ENCODED HOLOGRAM

(75) Inventors: Dietmar Eberhard, Kenzigen (DE); Wolfgang Riedel, Mullheim (DE); Dominik Giel, Bonn (DE); Karsten Sassenscheid, Merzhausen (DE)

Correspondence Address: BAKER & DANIELS LLP;111 E. WAYNE STREET, SUITE 800, FORT WAYNE, IN, 46802, US

(73) Assignee: FRAUNHOFER-GESELLSCHAFT ZUR FORDERUNG DER ANGEWANDTEN FORSCHUNG E.V., Munchen (DE)

(21) Appl. No.: 11/718,270

(22) PCT Filed: Oct. 14, 2005
(86) PCT No.: PCT/DE2005/001835

§ 371 Date: Apr. 30, 2007

(30) Foreign Application Priority Data
Oct. 31, 2004 (DE) 10 2004 053 071.8

(51) Int. Cl. G03H 1/30; G03H 1/22; G03H 1/10

(52) U.S. Cl. 359/10; 359/25

(57) ABSTRACT

The invention relates devices for recording or reading out an encoded hologram. Said devices are arranged to record or to read out spatially separated data structures, as well as mutually spatially separated data holograms (36) and positioning holograms (37) associated with positioning structures that are structurally simple compared to the data structures. Said positioning holograms (37) can be analyzed separately from the data holograms (36) in order to align a modulation pattern in an iteration. The hologram can thus be correctly aligned relatively easily even in the event of complex data structures or modulation structures.

### BACKGROUND OF THE INVENTION

1. Field of the Invention

The invention relates to a device for recording an encoded hologram.

2. Description of the Related Art

Devices for recording or reading out an encoded hologram are known for example from GB 2 196 443 A. In the prior known devices, the relative positioning of the hologram carrier must be done with the utmost precision, that is, with much greater precision than the characteristic dimensions of the modulation pattern, so that the data structure can be reconstructed. In practice, however, for example in connection with mass-produced products, this can be achieved only with difficulty.

It is known from WO 97/43669, to use in a volume hologram, in addition to an uncoded data hologram, an additional readout hologram containing data for adjusting the angle of a reference beam.

### SUMMARY OF THE INVENTION

The object underlying the invention is to disclose devices of the initially cited kind by means of which positioning can be performed that is suitable for practice.

In a device for recording an encoded hologram of the initially cited kind, this object is achieved according to the invention by the fact that the object has a positioning structure that is structurally simple compared to the data structure and is spatially separated from said data structure, and that means are present for spatially separately recording, on the one hand, the data hologram, and on the other, and a positioning hologram associated with said positioning structure.

In a device for reading out an encoded hologram of the initially cited kind, this object is achieved according to the invention by the fact that the hologram carrier comprises a positioning hologram corresponding to a positioning structure that is structurally simple compared to the data structure, and that means are present for relatively offsetting the modulation pattern and the hologram carrier in dependence on the image quality of the positioning structure.

By virtue of the fact that, in the inventive devices, the hologram carrier comprises, in addition to the data hologram, which is ordinarily associated with a relatively complex data structure, a positioning hologram associated with a positioning structure that is structurally simple compared to the data structure, position data can for one thing be written into the relatively translation-invariant positioning hologram in a simple manner during the recording of an encoded hologram, and for another are comparatively easy to regenerate during readout in order to correctly position the modulation pattern in relation to the data hologram, and can be used as output data for efficient iterative alignment of the modulation pattern relative to the hologram carrier.

The invention relates to a device for recording an encoded hologram, comprising a radiation source by means of which coherent output radiation can be generated, comprising an object able to be struck by the output radiation and containing in a hologram a data structure that is to be encoded, comprising a modulator able to be struck by the output radiation from the radiation source and by means of which a modulation pattern can be impressed on the output radiation striking said modulator, and comprising a hologram carrier to which a data hologram associated with said data structure can be written, the output radiation modulated by the data structure and the output radiation modulated by the modulation pattern being superimposed.

The invention further relates to a device for reading out an encoded hologram, comprising a radiation source by means of which coherent output radiation can be generated, comprising a modulator able to be struck by the output radiation from said radiation source and by means of which a modulation pattern can be impressed on the output radiation struck by said modulator, comprising a hologram carrier containing an encoded data hologram associated with a data structure and able to be struck by the output radiation modulated by the modulator, and comprising an image receiving unit by means of which an image of the data structure can be acquired.

In a useful configuration of an inventive device for recording an encoded hologram, the means for spatially separate recording comprise a mask arrangement to cover regions arranged to record the data hologram and/or the positioning hologram.

In a useful configuration of an inventive device for reading out an encoded hologram, the modulator is arranged to shift the modulation pattern over a region that at least corresponds to the tolerance for positioning the hologram carrier.

In a further useful configuration of the inventive device for reading out an encoded hologram, the means for relatively shifting the modulation pattern and the hologram carrier comprise a displacement device by means of which the hologram carrier can be moved with a precision corresponding to the characteristic structural dimensions of the modulation pattern.

In useful configurations of inventive devices, the positioning structure comprises an arrangement of spatially separated position image points.

In further useful configurations of inventive devices, the positioning structure has a simple geometric structure of comparatively high symmetry, such as for example a circle, a square, a rectangle or a star.

In further useful configurations of inventive devices, the positioning hologram is disposed spaced apart from the data hologram.

In an improvement of the latter configurations, the positioning hologram comprises two regions, each associated with one surface coordinate.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic representation of the structure of an exemplary inventive device for recording an encoded hologram;

FIG. 2 is a schematic representation of the structure of an exemplary inventive device for reading out an encoded hologram;

FIG. 3 is a schematic representation of a modulation pattern;

FIG. 4 is a schematic representation of a hologram recorded according to the invention and comprising, on the one hand, a data hologram, and on the other hand, a positioning hologram composed of two regions; and

FIG. 5 is a schematic representation of an image structure associated with a hologram according to the invention and comprising a data structure and a positioning structure.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

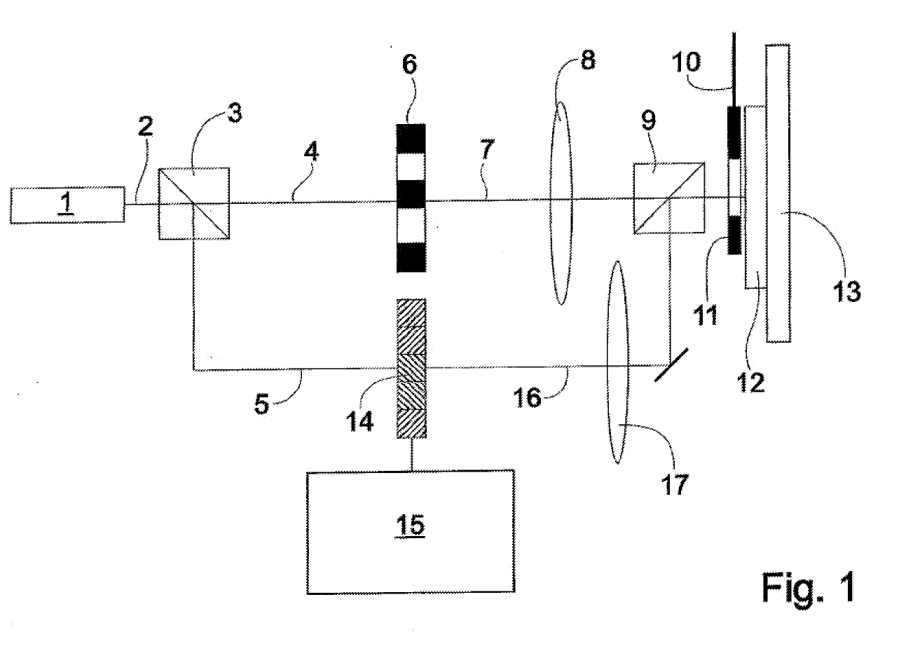

FIG. 1 is a schematic representation of the structure of an exemplary inventive device for recording an encoded hologram. The device according to FIG. 1 has as its radiation source a laser 1 operative to generate coherent output radiation 2. Disposed after the laser 1 in the direction of propagation of the output radiation 2 is a first beam splitter 3 operative to split the output radiation 2 into a first sub-beam 4 and a second sub-beam 5.

Disposed in the direction of propagation of first sub-beam 4 is an object 6 which is transparent to light in subregions and nontransparent to light in other subregions, and which comprises a data structure, for example in the form of a black and white image of an individual character string, which is to be encoded during the recording of the hologram. Said object 6 further comprises a positioning structure, which is structurally simple compared to the data structure and is also to be encoded during the recording of the hologram.

An object beam 7 modulated by the object passes via a Fourier optic 8 through a second beam splitter 9 and, after passing through a mask arrangement 11 whose optically effective shape can be varied by means of a mechanism 10, strikes a hologram carrier 12 disposed on a stationary carrier table 13.

The second sub-beam 5 strikes, as a modulator, a coding modulator 14, by means of which, to encode the hologram that is to be recorded, a modulation structure in the form of phase shifts that vary over the cross section of sub-beam 5 and are depicted schematically in FIG. 1 as different hashed areas, can be impressed on the second sub-beam 5. The configuration of the modulation structure can be adjusted by means of a control unit 15 connected to coding modulator 14. An encoding beam 16 generated from second sub-beam 5 after interaction with the coding modulator 14 strikes the second beam splitter 9 via an imaging optic 17, and also, superimposed with the object beam 7, strikes the hologram carrier 12.

When a hologram is to be recorded, the mask arrangement 11 can be adjusted so that it is possible to record in the hologram carrier 12, on the one hand, an encoded data hologram associated with the data structure, and on the other hand, an encoded positioning hologram associated with the positioning structure and spatially separated from the data hologram, but in a fixed spatial relationship therewith.

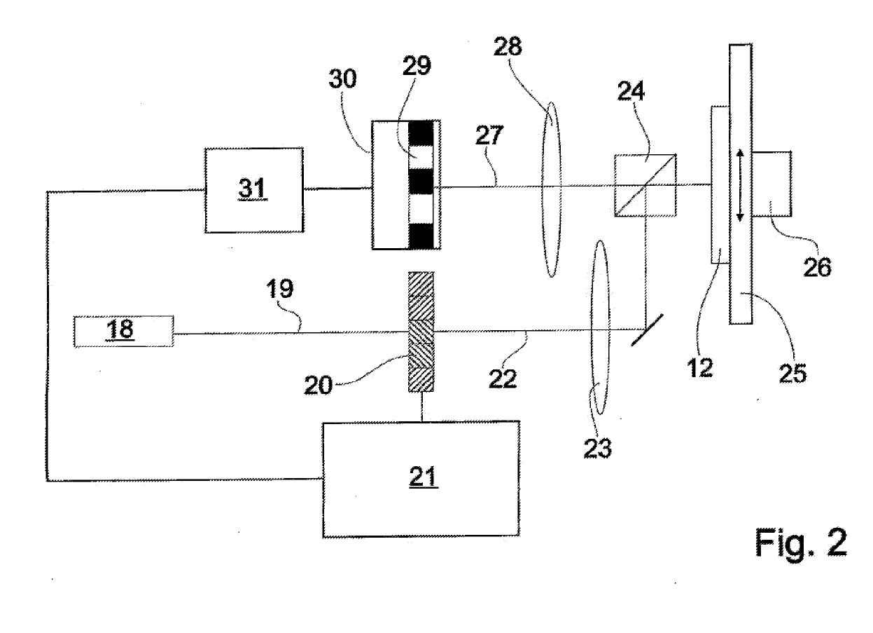

FIG. 2 is a schematic representation of the structure of an exemplary inventive device for reading out an encoded hologram that has been recorded on the hologram carrier 12 by means of the device explained with reference to FIG. 1. The device according to FIG. 2 has as its radiation source a laser 18 operative to generate coherent output radiation 19. Disposed as a modulator after the laser 18 in the direction of propagation of the output radiation 19 is a readout modulator 20, which, to read out a recorded encoded hologram, can be impressed with a modulation structure in the form of phase shifts that vary over the cross section of the output radiation 19 and are depicted schematically in FIG. 2 as different hashed areas.

The configuration of the modulation structure can be adjusted by means of a control unit 21 connected to readout modulator 20, and corresponds to the modulation structure generated by the coding modulator 14 on the recording of the hologram. A readout beam 22 generated from the output radiation 2 after interaction with readout modulator 20 strikes a beam splitter 24 via an imaging optic 23, and, superimposed with the object beam 7, strikes the hologram carrier 12 explained in connection with FIG. 1 and comprising the encoded data hologram and the encoded positioning hologram.

In the readout device according to FIG. 2, the hologram carrier 12 is disposed on a carrier table 25, which by means of a displacement device 26 can be shifted in two dimensions in the plane of the hologram carrier 12 in increments that at least correspond to the distance for which the modulation structure can be moved over the cross section of the output radiation 19 by means of the readout modulator 20.

After the readout beam 22 has interacted with the to-be-read-out hologram on hologram carrier 12, an object beam 27, after passing through beam splitter 24 and a Fourier optic 28, strikes a location-aware camera sensor 29, which is a component of a camera 30 of an image receiving unit. The output signal from the camera 30 can be fed to an image processing module 31 which is part of the image receiving unit and which, in order to perform an alignment process on the modulation pattern, as described in more detail below, is connected on the one hand to the control unit 21. In addition, by means of the image processing module 31, the output signal from the camera 30 can be displayed for example on a monitor (not shown in FIG. 2) and/or converted into an image data set that can be analyzed by means of a downstream data analyzer (also not shown in FIG. 2).

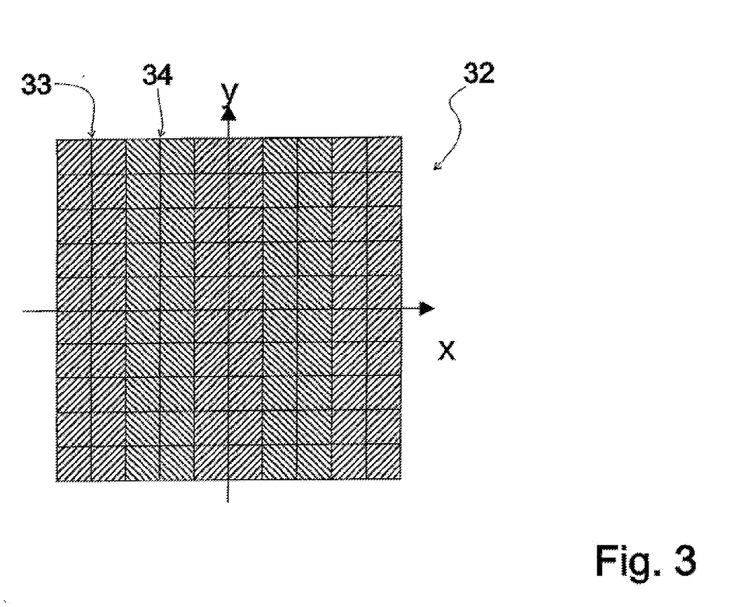

FIG. 3 is a schematic representation of a well-defined modulation pattern 32 of the kind that can be generated by means of the coding modulator 14 or the readout modulator 20. The modulation pattern 32 is composed of first phase regions 33 and second phase regions 34, which in the version shown extend alongside one another, ribbon-like, in the y-direction, and form regions respectively in the encoding beam 16 and in the readout beam 22 that exhibit phase shifts which differ by 180 degrees, as indicated by the contrasting hashing. It is understood that modulation patterns other than the ribbon-like arrangement of phase-shifted areas, particularly more complex ones, may be employed.

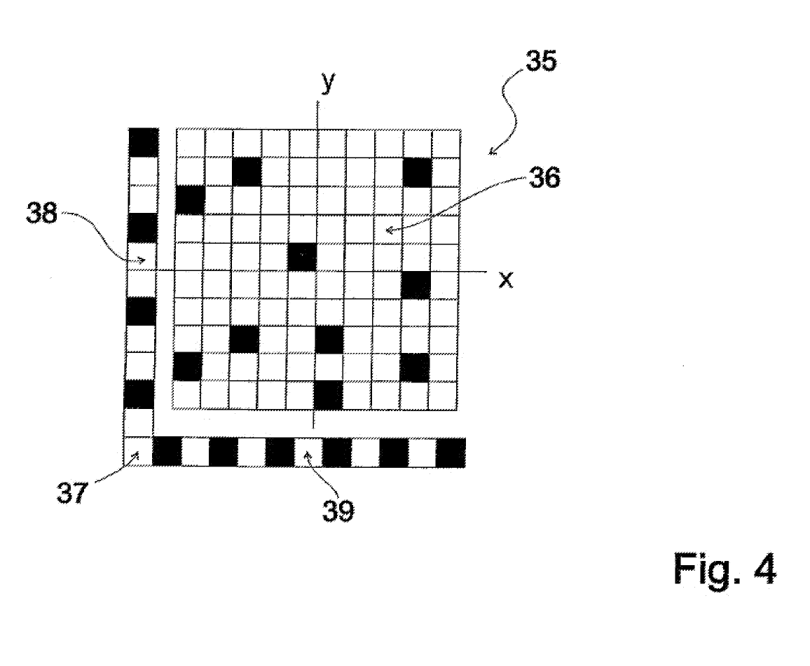

FIG. 4 is a schematic representation of an encoded hologram 35 which has been recorded and is to be read out according to the invention, and which comprises a data hologram 36 and a positioning hologram 37, the latter being disposed spaced apart laterally from said data hologram 36 and being formed with a first region 38 and a second region 39. Regions 38, 39 each have a hologram structure that is relatively translation-invariant in, respectively, the x-direction and the y-direction.

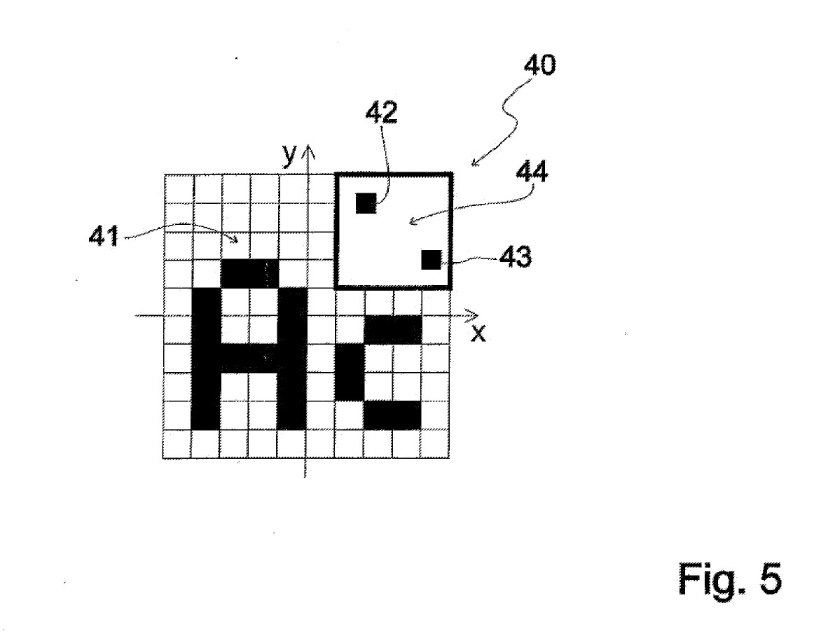

FIG. 5 is a schematic representation of an image structure 40 associated with a hologram 35 according to the invention and present in the object 6 and projected on the camera sensor 29, comprising a data structure 41 represented exemplarily by the letter sequence “Ac” and a positioning structure 44 that is formed by two position image points 42, 43 and is configured as structurally simple compared to the data structure 41. It can be seen from FIG. 5 that due to its structural simplicity, the positioning structure 44 generates a comparatively simple positioning hologram 37, which during readout generates in the positioning structure 44 image signals that can be evaluated at the beginning of the alignment process, even if there has been a shift in the modulation pattern 32, to effect an optimization which after relatively fast iteration yields sharp position image points 42, 43 and presents the data structure 41, reconstructed, in this alignment.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-9. (canceled)

10. A device for recording an encoded hologram, comprising:
a radiation source generating coherent output radiation along a path;
an object in said path of said output radiation and containing, in a hologram, a data structure that is to be encoded;
a modulator in said path of said output radiation, said modulator impressing a modulation pattern on said output radiation; and
a hologram carrier to which a data hologram associated with said data structure can be written, the output radiation modulated by said data structure and the output radiation modulated by said modulation pattern being superimposed, said hologram carrier including a positioning hologram having a positioning structure that is structurally simple relative to said data structure, said modulation pattern and said hologram carrier being shiftable relative to one another.

11. The device of claim 10, further comprising a mask arrangement for covering regions arranged to record at least one of said data hologram and said positioning hologram.

12. A device for reading out an encoded hologram, comprising:
a radiation source generating coherent output radiation along a path;
a modulator in said path of said output radiation, said modulator impressing a modulation pattern on said output radiation;
a hologram carrier containing a data hologram associated with a data structure and in said path of said output radiation modulated by said modulator, said hologram carrier further comprising a positioning hologram having a positioning structure that is structurally simple relative to said data structure, said modulation pattern and said hologram carrier shiftable in dependence on the image quality of said positioning structure; and
an image receiving unit acquiring an image of said data structure.

13. The device of claim 12, wherein said modulator is adapted to shift said modulation pattern over a region which at least corresponds to the tolerance for positioning said hologram carrier.

14. The device of claim 12, further comprising a displacement device by means of which said hologram carrier can be moved with a precision corresponding to the characteristic structural dimensions of said modulation pattern.

15. The device of claim 10, wherein said positioning structure comprises an arrangement of spatially separated position image points.

16. The device of claim 10, wherein said positioning structure has a simple geometric structure of comparatively high symmetry.

17. The device of claim 10, wherein said positioning hologram is disposed spaced apart from said data hologram.

18. The device of claim 17, wherein said positioning hologram comprises two regions, each associated with one surface coordinate.

19. The device of claim 12, wherein said positioning structure comprises an arrangement of spatially separated position image points.

20. The device of claim 12, wherein said positioning structure has a simple geometric structure of comparatively high symmetry.

21. The device of claim 12, wherein said positioning hologram is disposed spaced apart from said data hologram.

22. The device of claim 21, wherein said positioning hologram comprises two regions, each associated with one surface coordinate.
